(19) United States
(12) Patent Application Publication
(10) Pub. No.: US 2003/0087658 A1
(43) Pub. Date: May 8, 2003

(54) Partitioning responsibility between link manager and host controller interface firmware modules in wireless systems

(76) Inventors: Jane Dashevsky, Beaverton, OR (US); Hari K. Tadepalli, Phoenix, AZ (US)

Correspondence Address: Timothy N. Trop, TROP, PRUNER & HU, P.C., STE 100, 8554 KATY FWY, HOUSTON, TX, 77024-1805, US

(21) Appl. No.: 10/005,780

(22) Filed: Nov. 8, 2001

(51) Int. Cl. H04B 7/00

(52) U.S. Cl. 455/517; 455/524

(57) ABSTRACT

Tasks are distributed between link manager and host controller interface firmware to improve efficiency. In particular, the host controller interface firmware handles tasks that concern the overall state of the wireless device. Conversely, commands pertaining to each link between a local and remote device are processed by the link manager firmware.

### BACKGROUND

This invention relates generally to wireless communication protocols.

The Bluetooth wireless protocol utilizes connection and link management. See the Bluetooth Specification, Version 1.1, Feb. 22, 2001. Bluetooth technology uses short-range (10 meter) radio links to replace cable connections between a variety of electronic devices.

The Bluetooth specification calls for a protocol stack that includes a radio layer that forms a physical connection interface. A baseband and link manager protocol establish and control links between Bluetooth devices. A host controller layer interfaces the Bluetooth hardware to the upper protocol logical link control and adaptation layer (L2CAP). Applications reside above the L2CAP.

The baseband layer controls radio communications. The handling of packets over the wireless link involves the baseband layer. The baseband layer also facilitates the synchronization between clocks of connected wireless devices. It may also facilitate the inquiry procedures for determining addresses of proximate wireless devices.

The link management protocol (LMP) is responsible for security, link configuration and piconet management. A piconet is a group of devices connected to a common channel and identified by a unique hop sequence. Usually the device that initiates the connection is the master device and up to seven slave devices can be connected together to form a piconet. The link management protocol attaches and detaches slave devices, switches roles between masters and slaves, and establishes the different types of connections. The link management protocol also sets link parameters, quality of service, and power control in some cases.

A host controller interface resides between the L2CAP and the link management protocol. The lower layers, such as the radio, baseband and link management protocol layers, may be implemented in hardware. Data intended for the link management protocol and baseband layers travels over a physical bus. A driver for that bus may be necessary on a host that hosts the Bluetooth hardware.

A host controller interface is maintained between the host hardware and the physical bus. A host controller interface driver resides on the host and formats data to be accepted by the host controller. A host controller interface also resides in a host controller and accepts communications over the physical bus.

Firmware may implement certain key functions of any Bluetooth device including receiving host controller interface commands for setting and managing links, setting local device attributes, managing link quality, attending to critical events, such as timeouts, and translating L2CAP data packets into baseband packets. The host controller interface and link manager protocol firmware jointly handle all of these functions except translating data packets into baseband packets. The Bluetooth specification details the host controller interface and link manager protocols without specifying how these responsibilities may be partitioned into multiple tasks.

Thus, there is a need for techniques for partitioning the host controller interface and link manager protocol firmware so as to improve the logical separation of their functions, improve efficiency, increase command throughput, or distribute loads across the firmware.

### BRIEF DESCRIPTION OF THE DRAWINGS

FIG. 1 is a schematic depiction of one embodiment of the present invention; and

FIG. 2 is a flow chart showing connection establishment in accordance with one embodiment of the present invention.

### DETAILED DESCRIPTION

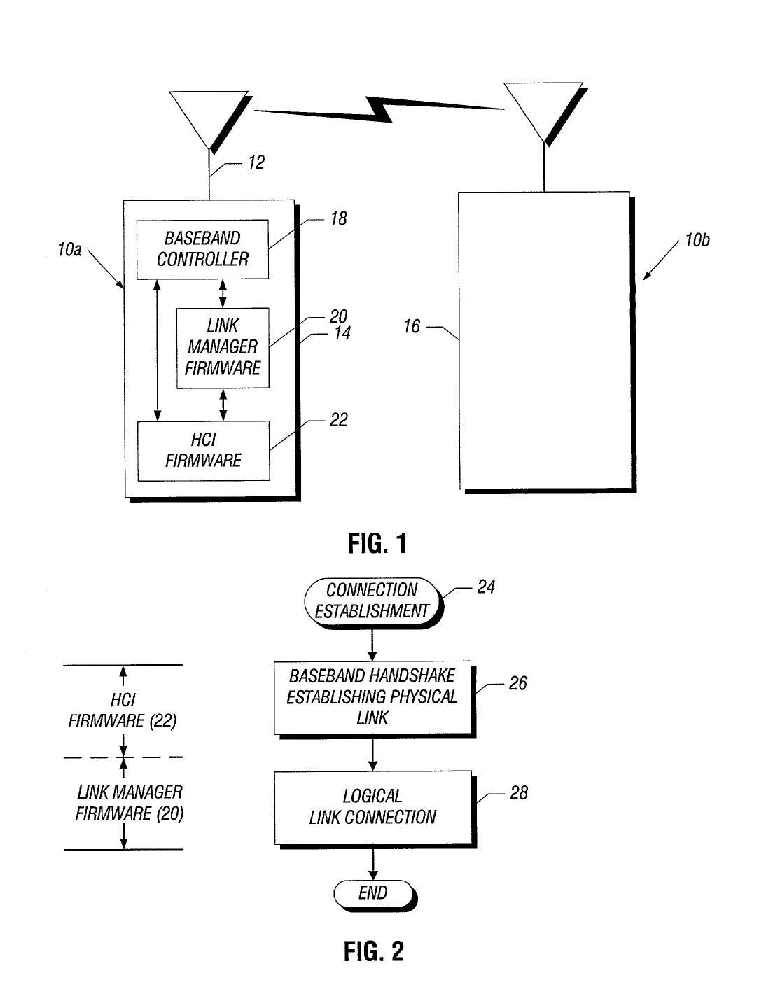

Referring to FIG. 1, a pair of Bluetooth devices 10 may communicate using a wireless protocol. Each device 10 may include an antenna 12 for this purpose. The devices 10a and 10b may be identical, each including a baseband controller 18 that communicates with link manager firmware 20 and host controller interface (HCI) firmware 22.

In accordance with one embodiment of the present invention, all host controller interface commands that concern the overall state of the Bluetooth device 10 are processed directly in the host controller interface (HCI) firmware 22. Commands pertaining to each particular link are processed by the link manager firmware 20. Thus, the state machine is distributed between the firmware 20 and 22. The HCI firmware 22 keeps track of the system wide state of the link controller of the Bluetooth device 10, while the link manager firmware 20 maintains the state of each link existing in a device 10.

Referring next to FIG. 2, the establishment of a wireless connection between the devices 10a and 10b involves a series of handshaking steps between the end points of the communication link. See Bluetooth specification. The baseband handshake that establishes a physical link 26 precedes the logical link connection 28. The baseband handshake may include the implementation of the inquiry mode wherein each device 10 attempts to determine what access points are in-range. In-range devices respond to an inquiry from an initiating device with their addresses. The initiating device 10 selects one of the responding devices with which to communicate.

To establish communications, a paging mode is implemented wherein the devices 10 synchronize with one another. Then, the devices 10 set up a physical layer connection and exchange information about the type of services available from each device.

As indicated in FIG. 2, during connection establishment, communication with hardware, including the processing of any possible time-outs, is handled by the host controller interface firmware 22. After the baseband portion of the connection is established, the host controller interface firmware 22 passes control, along with all required information, to the link manager firmware 20 for the establishment of the logical link.

The link manager firmware 20 negotiates the link attributes, such as a packet type, authentication, and encryption preferences, and establishes the logical link. The two Bluetooth devices 10 exchange link manager protocol data units (PDUs) as defined in the Bluetooth specification in order to exchange information on packet types, encryption and the like.

In some embodiments, the partitioning between the host controller interface and link manager firmware 20 and 22 may result in better logical separation of functions, improved efficiency because of fewer message layers, better command throughput, and more even processing load distribution across the firmware 20 and 22. Freeing the link manager firmware 20 from the system-wide link controller state management may also enable the link manager protocol to provide a faster response to protocol data units received from a link manager protocol of a peer device, in some embodiments.

Since the link management manages all the link properties busily, its share of the consumption of processor millions of instructions per second (MIPs) is relatively high. Processing inquiry (inquiry response) and paging (page response) commands are hardware intensive and are relegated to the baseband hardware. Not involving the link manager in these operations may improve the overall performance of the system while bringing down the processor MIPS requirement in some embodiments.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
handling the system-wide state of a wireless device through the host controller interface firmware; and
handling the state of each link with the device through the link manager firmware.

2. The method of claim 1 including initiating communications with connection and link management.

3. The method of claim 1 including establishing a connection between the device and an end point.

4. The method of claim 3 including handling baseband handshaking through the host controller interface firmware.

5. The method of claim 3 including handling logical link connection through the link manager firmware.

6. An article comprising a medium storing instructions that enable a processor-based system to:
handle the system-wide state of a wireless device through the host controller interface firmware; and
handle the state of each link with the device through the link manager firmware.

7. The article of claim 6 further storing instructions that enable the processor-based system to initiate communications with connection and link management.

8. The article of claim 6 further storing instructions that enable the processor-based system to establish a connection between the device and an end point.

9. The article of claim 8 further storing instructions that enable the processor-based system to handle baseband handshaking through the host controller interface firmware.

10. The article of claim 8 further storing instructions that enable the processor-based system to handle logical link connection through the link manager firmware.

11. A wireless system comprising:
a processor; and
a storage coupled to said processor storing instructions that enable the processor to:
handle the system-wide state of the system through the host controller interface firmware; and
handle the state of each link with the system through the link manager firmware.

12. The system of claim 11 wherein said storage stores instructions that enable the processor to initiate communications with connection and link management.

13. The system of claim 11 wherein said storage stores instructions that enable the processor to establish a connection between the system and a remote end point.

14. The system of claim 13 wherein said storage stores instructions that enable the processor to handle baseband handshaking through the host controller interface firmware.

15. The system of claim 13 wherein said storage stores instructions that enable the processor to handle logical link connection through the link manager firmware.
